(19) United States
(12) Patent Application Publication
(10) Pub. No.: US 2007/0216300 A1
(43) Pub. Date: Sep. 20, 2007

(54) Organic opto-electronic device with environmentally protective barrier

(75) Inventors: Chung J. Lee, Fremont, CA (US); Chieh Chen, Palo Alto, CA (US); Atul Kumar, Santa Clara, CA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: International Display Systems, Inc., Fremont, CA (US)

(21) Appl. No.: 11/800,938

(22) Filed: May 7, 2007

Related U.S. Application Data
(63) Continuation-in-part of application No. 11/009,285, filed on Dec. 8, 2004.
Application No. 11/009,285 is a continuation-in-part of application No. 10/116,724, filed on Apr. 4, 2002, now Pat. No. 6,881,447.

(51) Int. Cl. H01J 1/62; B05D 5/00

(52) U.S. Cl. 313/512; 313/498; 427/419.2

(57) ABSTRACT

An organic opto-electronic device is disclosed. One embodiment comprises a substrate, one or more organic device layers disposed over the substrate, and a multi-layer barrier disposed over the one or more organic device layers, the multi-layer barrier comprising a parylene-based layer and a layer comprising an ultraviolet protectant material.

### CROSS-REFERENCE TO RELATED APPLICATIONS

This application is a continuation-in-part of U.S. patent application Ser. No. 11/009,285, filed Dec. 8, 2004, which is a continuation-in-part of U.S. Pat. No. 6,881,447. Both of these documents are incorporated by reference herein.

### BACKGROUND

Organic photovoltaic cells recently have generated much commercial interest. Compared to conventional silicon-based photovoltaic cells, organic cells may offer several advantages. For example, organic photovoltaic cells may be lighter in weight, less expensive, and more flexible than silicon-based photovoltaic cells. However, organic photovoltaic cells are highly susceptible to environmental damage, as the organic photovoltaic materials may be damaged upon exposure to oxygen and moisture. Therefore, encapsulation solutions are required to prevent degradation of the organic layers in these materials. Similar problems with degradation due to exposure to oxygen and moisture are encountered with other organic opto-electronic devices, including but not limited to organic light emitting devices (OLEDs), and organic thin film transistors.

In addition, damage from solar ultraviolet radiation is also a major concern for organic photovoltaic devices. Due to degradation from exposure to oxygen, moisture and UV radiation, shorter lifetimes of these solar panels could potentially offset the advantages of lower manufacturing costs compared to those of conventional inorganic solar cells.

### SUMMARY

Accordingly, various embodiments of organic opto-electronic devices are described below in the Detailed Description. In one disclosed embodiment, an organic photovoltaic device comprises a substrate, one or more organic device layers disposed over the substrate, and a multi-layer barrier disposed over the one or more organic device layers, the multi-layer barrier comprising a layer of a parylene-based material and a layer comprising an ultraviolet protectant material.

In another disclosed embodiment, an organic opto-electronic device comprises a substrate, one or more organic device layers disposed over the substrate, and a multi-layer barrier disposed over the one or more organic device layers, the multi-layer barrier comprising a layer made substantially of PPX-F and a layer comprising one or more of zinc oxide and titanium oxide. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a flow diagram illustrating an embodiment of a method for forming a protective barrier in an organic opto-electronic device.

FIG. 2 is a schematic sectional view of an embodiment of an organic opto-electronic device having a protective barrier.

FIG. 3 is a schematic sectional view of another embodiment of an organic opto-electronic device having a protective barrier.

FIG. 4 is a schematic sectional view of another embodiment of an organic opto-electronic device having a protective barrier comprising a reflective layer formed beneath a parylene-based layer.

FIG. 5 is a schematic sectional view of another embodiment of an organic opto-electronic device having a protective barrier.

FIG. 6 is a schematic sectional view of another embodiment of an organic opto-electronic device having protective barriers formed on each side of the organic opto-electronic device layers.

FIG. 7 is a schematic depiction of a hermetic sealing lid sealed over an organic opto-electronic device.

### DETAILED DESCRIPTION OF THE DEPICTED EMBODIMENTS

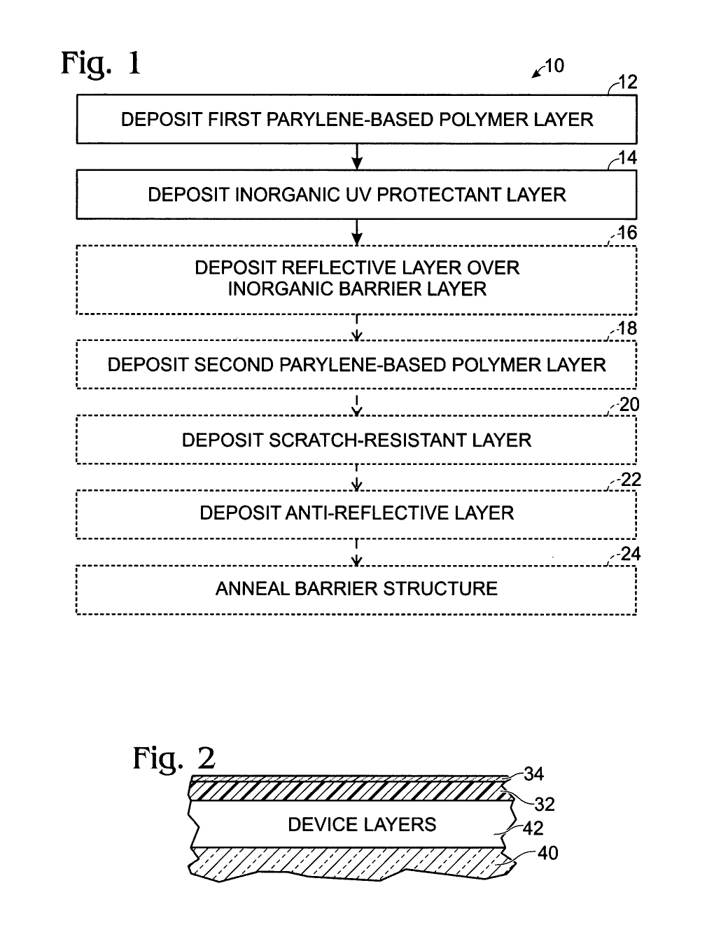

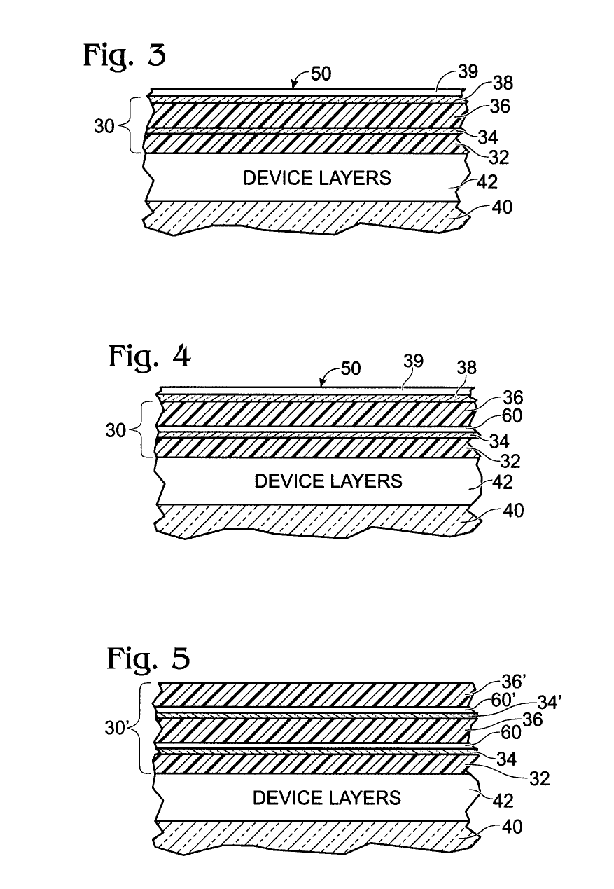

FIG. 1 illustrates, generally at 10, one exemplary embodiment of a method for forming a barrier layer in an organic opto-electronic device, and FIGS. 2 and 3 show schematic sectional views of example organic opto-electronic devices each having a barrier formed via the method of FIG. 1. Method 10 includes forming (at 12) a first parylene-based polymer layer over an underlying layer, forming (at 14) an inorganic barrier layer over the first parylene-based polymer layer, forming (at 16) an optional reflective layer, forming (at 18) an optional second parylene-based polymer layer over the anti-reflective layer, forming (at 20) an optional outer inorganic scratch-resistant layer, and forming (at 22) an optional anti-reflective layer over the other layers.

Prior to discussing these structures in more detail, it will be appreciated that the various layers described herein may be formed and arranged in any suitable order, and not necessarily in the specific orders shown in the depicted embodiments. Furthermore, it will be appreciated that, in some embodiments, a single layer may perform multiple functions. For example, where a barrier structure has one parylene-based polymer layer and one inorganic barrier layer, the inorganic barrier layer may also provide scratch-resistant properties and/or antireflective properties. Likewise, in other embodiments, each of these functions may be performed by separate layers.

FIG. 2 shows an organic opto-electronic device barrier structure comprising a single parylene-based layer and a single inorganic barrier layer, FIG. 3 shows a barrier structure with two parylene-based polymer layers and an inorganic barrier layer but without the optional reflective layer, and FIG. 4 shows a barrier structure similar to FIG. 3 but with a reflective layer 60. The first parylene-based polymer layer is shown in each of these figures at 32, the inorganic barrier layer is shown at 34, the second parylene-based polymer layer is shown at 36, an optional outer scratch-resistant layer is shown at 38, and an optional anti-reflective layer is shown at 39. The organic device layers are collectively shown by the layer 42 labeled “Device Layers.” It will be appreciated that the concepts and embodiments described herein may be used with any suitable organic opto-electronic device, including but not limited to organic photovoltaic devices, organic thin film transistors, and OLEDs.

As described below, the parylene-based polymer films of the embodiments described herein may be deposited under such conditions that the films have a relatively high initial crystallinity, for example, equal to or above 10%. The semi-crystalline and highly crystalline parylene-based polymers may be defined as polymers respectively having at least 10%, and up to 70%, crystallinity. A semi-crystalline, and especially a highly crystalline, parylene-based polymer film may have a greatly improved density and decreased free volume (which is defined as open volume in the amorphous area excluding pinholes and defects) compared to amorphous parylene films and other organic polymer films. Further, the semi- or highly-crystalline parylene-based polymer layers may have low-enough water vapor transport rate (“WVTR”) and oxygen transport rate (“OTR”) values that they not only “decouple” adjacent inorganic layers to help prevent the propagation of defects between inorganic layers, but also themselves help block water vapor and oxygen permeation into the organic opto-electronic device. In this sense, the semi-crystalline and highly crystalline parylene-based polymer films actually act as barrier layers. Therefore, an organic opto-electronic device having a barrier constructed with the semi-crystalline and highly crystalline parylene-based polymer barrier layers as described herein may have a significantly improved lifetime compared to prior organic opto-electronic devices having polyacrylate or amorphous parylene barrier layers. Each of these embodiments is described in more detail below.

Generally, the term “parylene-based polymer films” includes, but is not limited to, polymers having a general repeat unit of (—CZ¹Z²-Ar—CZ³Z⁴—), wherein Ar is an aromatic (unsubstituted, partially substituted or fully substituted), and wherein Z¹, Z², Z³ and Z⁴ are similar or different. In specific embodiments, Ar is C₆H₄₋ₓXₓ, wherein X is a halogen, and each of Z¹, Z², Z³ and Z⁴ individually are H, F or an alkyl or aromatic group. In one specific embodiment, a partially fluorinated parylene-based polymer known as “PPX-F” is used. This polymer has a repeat unit of (—CF₂—C₆H₄—CF₂—), and may be formed from various precursors, including but not limited to BrCF₂—C₆H₄—CF₂Br. In another specific embodiment, fully fluorinated poly(paraxylylene) is used. This polymer has a repeat unit of (—CF₂—C₆F₄—CF₂—). In yet another specific embodiment, unfluorinated poly(paraxylylene) (“PPX-N”) is used. This polymer has a repeat unit of (—CH₂—C₆H₄—CH₂—). It will be appreciated that these specific embodiments of parylene-based polymer films are set forth for the purposes of example, and are not intended to be limiting in any sense.

Various parylene-based polymer films may be formed via the CVD technique of transport polymerization as disclosed in U.S. Pat. No. 6,703,462, the disclosure of which is hereby incorporated by reference. Transport polymerization involves generating a gas-phase reactive intermediate from a precursor molecule at a location remote from a substrate surface and then transporting the gas-phase reactive intermediate to the substrate surface, wherein the substrate surface is kept below the melting temperature of the reactive intermediates for polymerization. For example, PPX-F may be formed from the precursor BrCF₂—C₆H₄—CF₂Br by the removal of the bromine atoms into the reactive intermediate *CF₂—C₆H₄—CF₂* (wherein * denotes a free radical) at a location remote from the deposition chamber, as described in U.S. patent application Ser. No. 10/854,776, filed May 25, 2004, the disclosure of which is hereby incorporated by reference. This reactive intermediate may then be transported into the deposition chamber and condensed onto a substrate surface, where polymerization takes place. Careful control of deposition chamber pressure, reactive intermediate feed rate and substrate surface temperature can result in the formation of a parylene-based polymer film having a high level of initial crystallinity. The film may then be annealed to increase its crystallinity and, in some cases, to convert it to a more dimensionally and thermally stable phase, as described in more detail below.

It has been found that parylene-based polymer films of significant initial crystallinity (equal to or greater than approximately 10%) may be formed via transport polymerization by condensing the reactive intermediate onto a substrate surface cooled to a temperature at least below the melting point of the reactive intermediate. Where the substrate temperature is in an suitable range, reactive intermediate molecules adsorb to the substrate surface with sufficient energy to reorient themselves along crystal axes before polymerization, thereby forming generally aligned polymer chains.

The conditions under which such crystalline growth occur may depend upon other variables besides the substrate temperature, including but not limited to, the system pressure, reactive intermediate feed rate, and system leak rate (system leakage can introduce free-radical scavengers, such as oxygen, water, etc. from the outside atmosphere that can terminate growth of the chains of the parylene-based polymers). In the specific example of PPX-F, examples of suitable ranges for these variables include, but are not limited to, the following: deposition chamber pressures of approximately 1 to 100 mTorr (and, in specific embodiments, approximately 5 to 25 mTorr); substrate temperatures of approximately −10 to −80 degrees Celsius (and, in specific embodiments, between approximately −25 to −45 degrees Celsius); and leakage rates of approximately 2 mTorr/min or less (and, in specific embodiments, as low as 0.4 mTorr/min or less). At these conditions, the precursor flow rate may be controlled to control the deposition rate of the polymer film. For example, in the case of a deposition system for 620 mm×375 mm rectangular substrate, a precursor flow rate of approximately 35 sccm may lead to deposition rates of approximately 2000 Angstroms/minute. Likewise, for a smaller 200 mm×200 m substrate system, a lower precursor flow rate of approximately 5 sccm may lead to similar deposition rates. It will be appreciated that these ranges are merely exemplary, and that processing conditions outside of these ranges may also be used to produce semi-crystalline parylene-based polymers.

The crystallinity of an as-deposited, semi-crystalline parylene-based polymer barrier film may be improved by annealing the film after deposition. The semi-crystalline films formed via the above-described deposition techniques result in the formation of generally-aligned polymer chains (as opposed to room-temperature depositions, which tend to result in highly randomly-oriented chain formation and an amorphous film). Therefore, annealing may provide sufficient energy to the semi-crystalline film to provide rotational energy to the polymer chains to improve the crystallinity of the barrier film. The use of an annealing process may improve the crystallinity of the semi-crystalline parylene-based polymer film from the initial 10% to as high as 70%, thereby greatly lowering the WVTR and OTR of the resulting film.

Another advantage offered by the semi-crystalline and highly crystalline parylene-based polymer films over polyacrylate films for use in barrier structures for organic opto-electronic devices is that these films are more thermally stable. For example, most amorphous polyacrylate has a glass transition temperature below 80 to 120° C., whereas PPX-F has a glass transition temperature of approximately 170° C. Therefore, higher temperature downstream processing steps may be used with the semi-crystalline parylene films of this disclosure versus polyacrylate. Furthermore, because the parylene films described herein are at least partially crystalline, only the amorphous portion of the parylene-based polymer film undergoes a phase transition at the glass transition temperature, thereby reducing the dimensional change due to this phase transition and its effects on the organic devices. Additionally, annealing the semi-crystalline parylene-based polymer film to increase the crystallinity of the film has the additional advantage that the quantity of amorphous film that transitions to a glass phase upon cooling past the glass transition temperature may be greatly reduced.

The parylene-based polymer layers may have any suitable thickness. Suitable thicknesses for these layers include, but are not limited to, thicknesses between approximately 1000 and 30,000 Angstroms.

The use of PPX-F may offer various advantages over the use of other parylene-based materials. For example, compared to other parylene-based polymers, PPX-F may offer the advantages of higher crystallinity, better solvent resistance, higher Young's modulus, better dimensional stability through thermal cycles, absence of water absorption, and lower water vapor transport and oxygen transport rates.

Further, the specific transport polymerization processes through which PPX-F films are formed may allow more precise control of the film thickness relative to the deposition of other types of parylene-based films. For example, PPX-N is generally deposited via a method known as the Gorham method. This involves the evaporating a solid dimer having a formula of (CH₂C₆H₄CH₂)₂ at temperatures ranging from 125-160° C. to create a sufficient vapor pressure of the dimer, and then controlling the feed rate of the precursor into a deposition chamber via a needle valve. However, the deposition rate may be difficult to control with sufficient precision utilizing a needle valve. A high temperature vapor phase controller may be used in place of a needle valve to provide a higher degree of control of the deposition rate. However, the high temperatures (>160° C.) required to maintain the dimer in the vapor phase may significantly shorten the lifetime of the electronics in the vapor phase controller In contrast, the deposition of PPX-F can be performed using a precursor heated to, for example, approximately 70-90° C. using a vapor phase controller operated at a temperature of approximately 120° C. Such conditions may have less of a shortening effect on the lifetime of the high temperature vapor phase controller. Furthermore, the PPX-F film thickness may also be controlled by controlling the temperature of the substrate during deposition, as cooling the substrate may cause more intermediate to adsorb to the substrate from the vapor phase, and therefore may increase deposition rates. It will be appreciated that the specific temperature to which the precursor is heated may be system-dependent, as systems for depositing films on large substrates may utilize higher temperatures than systems for depositing films on smaller substrates to create a larger flow of precursors.

While annealing may significantly improve the dimensional stability and moisture- and oxygen-barrier properties of a semi-crystalline parylene-based polymer film, it will be appreciated that even an as-deposited and un-annealed semi-crystalline parylene-based polymer film formed via the methods described herein may have sufficient crystallinity for use as a barrier layer. Where annealing is not performed, deposition conditions for parylene-based layers 32 and 36 may be optimized to provide a film with sufficient moisture and oxygen barrier properties. Table I below shows the results of a series of experiments to optimize the deposition conditions for PPX-F and PPX-N encapsulant films to obtain satisfactory moisture and oxygen barrier characteristics without annealing. The barrier characteristics of the films were tested by first adhering particles of calcium sulfate doped with CoCl₂ to a silicon wafer substrate. The particles were adhered to the wafer using a non-water-absorbing polysiloxane adhesive. Next, PPX-F and PPX-N films were deposited over the particles to encapsulate the particles and the adhesive. No inorganic encapsulant layers were used. After encapsulation, the samples were removed from vacuum and exposed to ambient in the presence of a control sample made up of unencapsulated calcium sulfate particles. Cobalt chloride turns from blue to pink in color when exposed to moisture absorbed by the calcium sulfate. Therefore, the particles were monitored for change in color to determine approximate rates of oxygen and water permeabilities.

The unencapsulated calcium sulfate particles showed a lifetime of approximately 20 minutes when exposed to ambient. The lifetime of the calcium sulfate particles encapsulated by unannealed PPX-F and PPX-N films deposited under a series of substrate temperatures are as follows. The depositions were performed using feed rates ranging from 3-5 sccm for PPX-F, and a dimer temperature of about 100 C. for PPX-N.

TABLE I

| | Substrate | | |
|---|---|---|---|
| | Temperature | Deposition Rate | Lifetime |
| Encapsulant | (° C.) | (Å/minute) | (Hours/um film) |
| PPX-N | 0 | 675 | 9 |
| | −10 | 1000 | 9 |
| | −20 | 1167 | 5 |
| | −30 | 1265 | 2 |
| PPX-F | 10 | 120 | 48 |
| | −10 | 375 | 33 |
| | −20 | 570 | 28 |
| | −40 | 1000 | 15 |

As is evident from Table I, unannealed PPX-F was found to offer better barrier properties than unannealed PPX-N. Further, this indicates that deposition rates and substrate temperatures may be varied to optimize barrier properties and throughput rates in production. Continuing with FIGS. 1-4, inorganic barrier layer 34 is formed after forming first parylene-based polymer layer 32 and before forming the optional second parylene-based polymer layer. Likewise, optional outer scratch-resistant layer 38 is formed after second parylene-based polymer layer 36, or may be formed directly on first parylene-based polymer layer 32 where second parylene-based polymer layer 36 is omitted. The thermal stability of the semi-crystalline parylene-based polymers used in first parylene-based polymer layer 32 and second parylene-based polymer layer 36 allows the use of chemical vapor deposition techniques to form inorganic barrier layer 34 and scratch resistant layer 38 as an option. This is in contrast to polyacrylate, which requires the use of lower temperature techniques such as sputtering to be used to form inorganic barrier layers. Chemical vapor deposition techniques may generate better barrier films and allow higher throughput than sputtering techniques.

Any suitable materials may be used to form inorganic barrier layer 34 and/or outer scratch-resistant layer 38. Examples of suitable materials include, but are not limited to, aluminum, alumina, SiO₂, SiOₓN_{y} and SiₓN_{y}. Likewise, inorganic barrier layer 34 and outer scratch-resistant layer each may have any suitable thickness. Suitable thicknesses include, but are not limited to, thicknesses between 500 and 5000 Angstroms.

Further, where the organic device is an organic photovoltaic device, inorganic barrier layer 34 and/or outer scratch-resistant layer 38 may comprise an ultraviolet protectant material to protect the organic device layers from damage by solar ultraviolet radiation. Examples of ultraviolet protectants include, but are not limited to, zinc oxide and titanium oxide. Both of these materials strongly absorb broad spectrums of ultraviolet radiation but are generally transparent to visible light. Therefore, the use of these materials in an inorganic barrier layer may help to prolong the life of an organic photovoltaic device while not impeding device performance.

Optional anti-reflective layer 39 may likewise be formed from any suitable material or materials, and may have any suitable thickness. Further, anti-reflective layer 39 may comprise a single layer of material, or multiple layers of materials. In some embodiments, anti-reflective layer 39 and scratch-resistant layer 38 may comprise a single layer, where the material used has both properties. Additionally and/or alternatively, layer 39 may be configured to be reflective to UV light but transparent to visible light, thereby offering additional protection against UV degradation of the organic device materials. In one embodiment, layer 39 may comprise a Bragg reflector configured to reflect UV light, as explained below regarding reflective layer 60.

Continuing with FIGS. 1-4, reflective layer 60 (shown in FIG. 4) may be used in combination with a directed annealing process to protect organic device layers during an annealing process. Such an annealing process may help protect the organic device layers relative to hotplate or oven annealing. One example embodiment of a method of directing annealing energy to the semi-crystalline parylene-based polymer films with specificity comprises utilizing optional reflective layer 60 in combination with a laser or focused infrared annealing process. The laser may be directed initially onto face 50 of barrier 30. Radiation from the laser passes through second parylene-based polymer layer 36 and then onto reflective layer 60, which reflects the laser beam back through second parylene-based polymer layer 36. Thus, reflective layer 60 may help to prevent the laser beam from penetrating into and harming the organic device layers 42.

Any suitable material may be used as optional reflective layer 60. For example, in bottom emitting OLEDs, light is emitted through the substrate 40. Therefore, in these structures, reflective layer 60 may be opaque without affecting device performance. Suitable opaque materials for reflective layer 60 include, but are not limited to, aluminum and other metals. On the other hand, in top-emitting OLEDs, light is emitted through the device face opposite the substrate (indicated at 50 in FIGS. 3-4). Likewise, in organic photovoltaic cells, solar energy may be absorbed through face 50. Therefore, in these devices, reflective layer 60 must transmit light emitted by the OLED or light to be absorbed by the photovoltaic device. In this case, reflective layer 60 may be formed from a Bragg reflector, which is formed from a plurality of alternating layers of a high dielectric constant material and a low dielectric constant material. The reflectivity of the layer may be tuned by giving each layer a thickness of one-quarter of the wavelength of the radiation to be reflected, or may be given a broad band of reflectivity by varying the thicknesses of the individual dielectric layers. Therefore, if the organic opto-electronic device emits visible light (in the case of an OLED) or absorbs visible light (in the case of a photovoltaic device), reflective layer 60 may be configured to reflect a substantial portion of, or even substantially all, radiation in the ultraviolet range, and a UV-eximer laser (or other suitable UV laser) may be used to anneal second parylene-based polymer layer 36. Suitable dielectric sub-layers to be used as layers in a Bragg reflector arrangement for reflective layer 60 include, but are not limited to, SiO₂, SiₓN_{y}, SiOₓN_{y}, Ta₂O₅, TiO₂, ZnO and other metal oxides. The use of TiO₂ and/or ZnO may offer the additional advantage of absorbing ultraviolet light, thereby providing additional protection from UV energy used to anneal layer 36, as well as from solar UV radiation for organic photovoltaic devices. It will be appreciated that other layers besides reflective layer 60 may also comprise a Bragg reflector configured to reflect ultraviolet light and transmit visible light, including but not limited to anti-reflective layer 39.

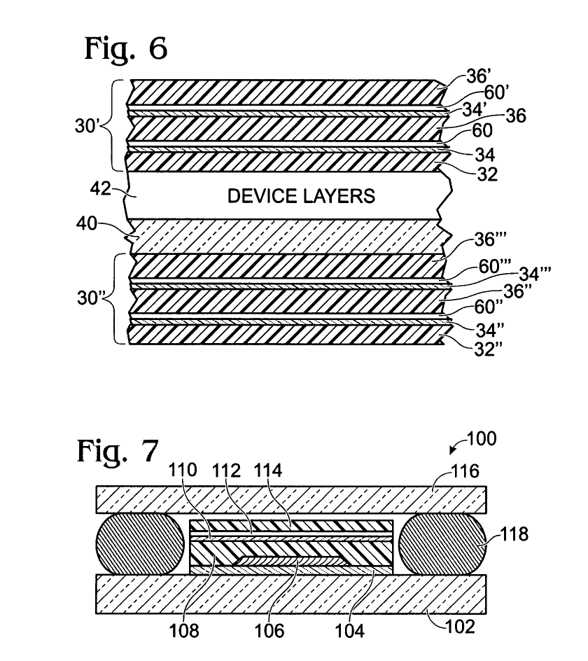

The embodiments of FIGS. 2-4 depict a single barrier 30 formed over device layers 42. If desired, more than one barrier 30 may be formed over and/or under the device layers 42 to provide additional protection from oxygen, water vapor and/or other environmental gases. FIGS. 5 and 6 depict alternate embodiments having more than a single barrier 30. First regarding FIG. 5, barrier 30′ includes an additional inorganic barrier layer 34′ formed over second semi-crystalline or highly crystalline parylene-based layer 36 of first barrier 30, an additional (optional) reflective layer 60′, and a third parylene-based polymer layer 36′. It will be appreciated that reflective layer 60 in first barrier 30 may provide sufficient protection for the underlying organic device layers that reflective layer 60′ may be omitted (or both may be omitted when suitable). The use of the additional inorganic barrier 34′ and third semi-crystalline or highly crystalline parylene-based polymer layer 36′ in barrier 30′ may offer greater resistance to water vapor and oxygen where desired compared to the use of barrier 30.

Next, in the embodiment of FIG. 6, two barriers, 30′ and 30″, are provided over and beneath the organic device layers, respectively. Barrier 30″ is positioned on an opposite face of substrate 40 as the organic device layers. This helps to prevent water vapor and oxygen from contaminating the organic device layers when a flexible plastic substrate 40′ is used, for example, to manufacture a flexible organic device. The depicted barrier 30″ has a similar structure to barrier 30′ (i.e. layers 32″, 34″, 36″, 60″, 34′″, 36′″, and 60′″ of barrier 30″ correspond to layer 32, 34, 36, 60, 34′, 36′, and 60′ of barrier 30′, respectively), but it will be appreciated that barrier 30″ may have either more or fewer inorganic barrier layers and/or organic barrier layers. Furthermore, it will be appreciated that any desired numbers of layers of parylene-based polymer barrier layers and inorganic barrier layers may be disposed below and/or above the organic device layers to provide as much protection against oxygen and water vapor as desired.

The multi-layer barriers disclosed herein may also be used to provide temporary protection to an organic opto-electronic by forming an encapsulated device pending for further “glass-sealing” or “hermetic sealing” of the encapsulated device under atmospheric conditions, i.e. outside of a vacuum environment. This packaging method removes the time consuming glass-sealing or hermetic sealing step from the costly vacuum deposition system. “Glass-sealing” refers to sealing a glass cover to a glass substrate that already has a device fabricated on the substrate. The glass sealing may also include sealing desiccant inside the glass packages to increase the lifetime of the sealed package. “Hermetic sealing” refers to sealing methods that essentially permanently prevent all external chemical species, including water vapor and oxygen, from entering the sealed device package per the MIL-STD-883 standard.

Many hermetic sealing methods have been developed in the semiconductor packaging industries over the last three decades. However, these hermetic sealing methods may be difficult to apply directly to current organic device manufacturing process. This is at least because these hermetic sealing techniques are performed either at high temperatures under vacuum, or under an atmospheric environment. As described above, due to the environmental sensitivity of the materials used in organic opto-electronic devices, the devices typically must be encapsulated or otherwise protected from the outside atmosphere before being removed from the vacuum fabrication environment. Furthermore, the organic materials used in such devices may not be able to withstand the high temperatures of the vacuum hermetic sealing methods. Therefore, the glass or metal protective canisters of current commercial organic opto-electronic devices are bonded over the organic opto-electronic devices with a UV-curable adhesive. The resulting seal is not hermetic, and a desiccant must be added to the canister interior to trap any moisture able to diffuse through the seal. Even with the desiccant, device lifetimes of only 2 years or so are achieved, because the glues used are typically organic polymers with comparatively high WVTR and OTR values. The method disclosed in the above-described U.S. Pat. No. 6,570,325 to Graff et al. is not hermetic, and may only achieve about half of the lifetime as the double-glass-sealed organic opto-electronic device package with included desiccant.

To allow an off-vacuum line sealing with a glass/glue, metal/glue, or hermetic enclosure to be fabricated around an organic opto-electronic device, the organic opto-electronic device may first be subjected to a pre-glass- or pre-hermetic-sealing process (or encapsulation step) in which a barrier film is deposited over the active device layers of the organic opto-electronic device, before the organic opto-electronic device is removed from the vacuum fabrication environment. The barrier film may be a single layer of one of the semi-crystalline parylene-based polymer films described herein, and/or may also include inorganic layers disposed over the semi-crystalline parylene-based polymer films. The barrier film may also include a stack of multiple alternating layers of semi-crystalline parylene-based films and inorganic films. Furthermore, the barrier film may include a polymer film made from a polymer other than a semi-crystalline parylene-based polymer, in combination with an appropriate inorganic film.

Depending upon the barrier film used, such a barrier film may protect the organic opto-electronic device from oxygen and water vapor for a period of days (for a single parylene-based polymer film as disclosed herein) to months or even years (for a barrier film having multiple alternating layers of parylene-based polymer films and inorganic films). Furthermore, a deposition chamber for forming the barrier layer or stack may be connected directly to vacuum chambers for the formation of the organic device layers. Such a configuration would allow the barrier film formed immediately after deposition of the cathode without breaking system vacuum.

After fabricating the barrier layer or layers to form an encapsulated organic device, the encapsulated organic device may be hermetically sealed under atmospheric conditions without causing damage to the organic cathode. FIG. 7 depicts an exemplary embodiment of an encapsulated and hermetically (or near-hermetically) sealed organic device, generally at 100. Encapsulated and hermetically sealed organic device 100 includes a substrate 102, an anode 104, an organic region 106, all covered by a barrier layer as disclosed above. The barrier layer includes a first semi-crystalline parylene-based polymer layer 108, an inorganic barrier layer 110, a reflective layer 112 and a second semi- or highly crystalline parylene-based polymer layer 114. A hermetic lid 116 is positioned over the organic device, and a hermetic sealing material 118 is used to seal the gap between substrate 102 and lid 116. While the depicted barrier layer includes both semi-crystalline (and/or highly crystalline) parylene-based polymer layers and inorganic barrier layers, it will be appreciated that it may include either more or fewer polymer and/or inorganic barrier layers.

Any suitable hermetic sealing technique and materials may be used. Suitable hermetic sealing techniques include, but are not limited to, techniques performed at temperatures that the organic layers within the organic device can withstand and/or techniques that involve localized heating that does not damage the organic layers. For a frontside-emitting device, light is not emitted through the lid; therefore, either metal or ceramic lids may be used. For a backside-emitting device, the lid must transmit emitted light, so a transparent glass or ceramic lid may be used. Examples of suitable hermetic sealing methods are set forth in Table II.

TABLE II

| Hermetic | Hermetic | | | | | Examples of Suitable |
|---|---|---|---|---|---|---|
| Sealing Process | Lid Type | Hermetic Sealing Materials | | Sealing Temperature | | Heating Methods |
| Soldering | Metal | 1. | Tin-lead solder | 1. | Fast preheat period | Focused IR |
| | | 2. | Tin-lead with additions | | (3-5 minutes) | |
| | | | of indium and silver | 2. | Minimum time (3-5 minutes) | |
| | | 3. | Bismuth-tin alloys | | above the sealer's | |
| | | | | | melting temperature | |

| | | | | | |
|---|---|---|---|---|---|
| | | | 3. | Peak temperature of | |
| | | | | 40° C. to 80° C. above | |
| | | | | the melting temperature | |
| | | | 4. | Fast cool-down | |
| | | | | after solidification | |
| Brazing | Metal | Eutectic gold-tin alloy | 1. | 2-4 minutes above the | Localized electrical |
| | | | | eutectic temperature | heating |
| | | | | of 280° C. | |
| | | | 2. | peak temperature of | |
| | | | | 350° C. | |

| Parallel Seam | Metal | Nickel or gold plating | | Localized high | AC current pulse | |
|---|---|---|---|---|---|---|
| Welding | | | | temperature | | |
| (Series Welding) | | | | | | |
| Laser | Metal | Nickel or gold plating | | Very localized high | 1. | CO₂ laser |
| Welding | | | | temperature | 2. | Nd-Yag laser |
| Glass Sealing | Metal, | 1. | Lead-zinc-borate | Below 420° C. | 1. | Furnace sealing |
| | ceramic | | glasses | | 2. | IR heaters |
| | or glass | 2. | Lead-zinc-borate glass | | 3. | Focused IR light |
| | | | with addition of low- | | | |
| | | | CTE fillers such as | | | |
| | | | fused silica and | | | |
| | | | betaeucryptite | | | |

Because many organic light emitting materials are thermally unstable at relatively low temperatures, those hermetic sealing methods that utilized localized or highly localized heating may be particularly suitable. Such methods include, but are not limited to, CO₂ and Nd-Yag lasers, focused infrared heaters, pulsed AC currents and a reactive nano-foil such as RNT FOIL sold by RNT of Hunt Valley, Md. This reactive micro-foil includes nano-particles that under heat activation can generate localized heating for pre-blazed substrate surface, thereby resulting in hermetic sealing while avoiding thermal damage. The details of this technology can be found on the Internet at www.RNTfoil.com. Using these heating these localized heating methods, materials such as gold-lead alloys, lead-tin or bismuth-tin solders, and vitreous glasses prepared from lead-zinc borate or its composites consisting of fused silica can be used to seal a hermetic canister or lid over the parylene-based polymer film-coated organic device.

Because the transport polymerization of semi-crystalline parylene-based polymer films results in the formation of a conformal polymer film, the edges of the organic device may be cleaned to expose the pad or lead area for interconnect to ICs. This may be done using shadow mask or photo-resist and plasma etching techniques. In addition, the edge of the substrate may be cleaned of any parylene-based polymer film present in the regions where hermetic sealing is to be performed before sealing the hermetic lid to the substrate. Cleaning may be performed via laser ablation, using a shadow mask or photo-resist and preferably with plasma etching techniques, or via any other suitable method.

Although the present disclosure includes specific embodiments of barriers for organic devices and methods of forming the barriers, specific embodiments are not to be considered in a limiting sense, because numerous variations are possible. The subject matter of the present disclosure includes all novel and nonobvious combinations and subcombinations of the various films, processing systems, processing methods and other elements, features, functions, and/or properties disclosed herein. The description and examples contained herein are not intended to limit the scope of the invention, but are included for illustration purposes only. It is to be understood that other embodiments of the invention can be developed and fall within the spirit and scope of the invention and claims.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. An organic photovoltaic device, comprising:
a substrate;
one or more organic device layers disposed over the substrate; and
a multi-layer barrier disposed over the one or more organic device layers, the multi-layer barrier comprising a parylene-based layer and a layer comprising an ultraviolet protectant material.

2. The organic photovoltaic device of claim 1, wherein the parylene-based layer comprises PPX-F.

3. The organic photovoltaic device of claim 2, wherein the PPX-F has a crystallinity of 10% or greater.

4. The organic photovoltaic device of claim 1, wherein the ultraviolet protectant material comprises one or more of zinc oxide and titanium oxide.

5. The organic photovoltaic device of claim 1, wherein the layer comprising the ultraviolet protectant material has a thickness of approximately 50-5000 Angstroms.

6. The organic photovoltaic device of claim 1, wherein the layer comprising the ultraviolet protectant material is a multi-layer structure comprising a Bragg reflector.

7. The organic photovoltaic device of claim 1, wherein the multi-layer barrier further comprises a plurality of parylene-based layers alternating with a plurality of layers comprising the ultraviolet protectant material.

8. The organic photovoltaic device of claim 1, wherein the layer of the parylene-based material has a thickness of approximately 1000-20,000 Angstroms.

9. The organic photovoltaic device of claim 1, wherein the substrate is glass.

10. The organic photovoltaic device of claim 1, wherein the substrate is a flexible plastic material, wherein the multi-layer barrier is a first barrier, and further comprising a second multi-layer barrier disposed over the substrate on an opposite side of the substrate as the first barrier, the second multi-layer barrier comprising a layer of a parylene-based material and a layer of an ultraviolet protectant material.

11. The organic photovoltaic device of claim 1, further comprising a Bragg reflective layer disposed beneath the parylene-based polymer layer.

12. The organic photovoltaic device of claim 1, further comprising a scratch-resistant outer layer.

13. The organic photovoltaic device of claim 1, further comprising at least one inorganic barrier layer comprising one or more of aluminum, alumina, SiO₂, SiOₓN_{y} and SiₓN_{y}.

14. An organic opto-electronic device, comprising:
a substrate;
one or more organic device layers disposed over the substrate; and
a multi-layer barrier disposed over the one or more organic device layers, the multi-layer barrier comprising a layer made substantially of PPX-F and a layer comprising one or more of zinc oxide and titanium oxide.

15. The organic opto-electronic device of claim 14, wherein the layer made substantially of PPX-F has a crystallinity of at least 10%.

16. The organic opto-electronic device of claim 14, wherein the multi-layer barrier further comprises a plurality of parylene-based layers alternating with a plurality of layers comprising one or more of zinc oxide and titanium oxide.

17. The organic opto-electronic device of claim 14, wherein an outermost layer of the barrier is a layer of one or more of zinc oxide and titanium oxide.

18. The organic opto-electronic device of claim 14, wherein the parylene-based layer has a thickness of approximately 1000-20,000 Angstroms.

19. The organic opto-electronic device of claim 14, wherein the substrate is a flexible plastic material, wherein the multi-layer barrier is a first barrier, and further comprising a second multi-layer barrier disposed over the substrate on an opposite side of the substrate as the first barrier.

20. A method of forming a protective multi-layer barrier to protect an organic photovoltaic device, comprising:
forming a parylene-based polymer layer over the organic photovoltaic device; and
forming an inorganic layer comprising one or more of zinc oxide and titanium oxide over the organic photovoltaic device.

21. The method of claim 20, further comprising forming a plurality of alternating parylene-based polymer layers and ultraviolet blocking layers over the organic photovoltaic device.

22. The method of claim 20, wherein the parylene-based polymer layer comprises PPX-F.

23. The method of claim 22, wherein the PPX-F has a crystallinity of at least 10%.

24. The method of claim 20, wherein the organic photovoltaic device is formed on a frontside of a flexible substrate, and further comprising forming a protective multi-layer barrier over a backside of the flexible substrate.

25. The method of claim 24, wherein the multi-layer barrier over the backside of the flexible substrate comprises at least a layer of a parylene-based polymer and a layer comprising one or more of zinc oxide and titanium oxide.

26. The method of claim 24, further comprising forming a Bragg reflective layer configured to reflect substantial amounts of UV light and to pass substantial amounts of visible light.

27. An organic opto-electronic device, comprising:
a substrate;
one or more organic device layers disposed over the substrate; and
a Bragg reflector disposed over the one or more organic device layers, wherein the Bragg reflector is configured to transmit a substantial portion of incident visible light and reflect a substantial portion of incident ultraviolet light.

28. The organic opto-electronic device of claim 27, wherein the device further comprises one or more layers of a parylene-based polymer.
